(19) United States
(12) Patent Application Publication
(10) Pub. No.: US 2008/0227631 A1
(43) Pub. Date: Sep. 18, 2008

(54) Method for Producing a Catalyst for the Desulfurization of Hydrocarbon Flows

(75) Inventors: Friedrich Schmidt, Rosenheim (DE); Frank Grossmann, Munchen (DE); Richard Fischer, Bad Aibling (DE); Michael Rau, Manama (BH)

Correspondence Address: SCOTT R. COX;LYNCH, COX, GILMAN & MAHAN, P.S.C., 500 WEST JEFFERSON STREET, SUITE 2100, LOUISVILLE, KY, 40202, US

(73) Assignee: Sud-Chemie AG, Munchen (DE)

(21) Appl. No.: 11/814,388

(22) PCT Filed: Jan. 31, 2006
(86) PCT No.: PCT/EP06/00816

§ 371 Date: Mar. 18, 2008

(30) Foreign Application Priority Data
Jan. 31, 2005 (DE) 10 2005 004 429.8

(51) Int. Cl. B01J 23/28; B01J 23/72; B01J 23/06

(52) U.S. Cl. 502/307

(57) ABSTRACT

The invention relates to a process for preparing a catalyst for the desulfurization of hydrocarbon streams, which comprises the steps:
(a) preparation of an aqueous suspension comprising:
   a thermally decomposable copper source,
   a thermally decomposable molybdenum source, and
   a solid zinc source;
(b) heating of the suspension to a temperature at which the thermally decomposable copper source and the thermally decomposable molybdenum source decompose so that a suspension of a precipitate comprising zinc compounds, copper compounds and molybdenum compounds is obtained;
(c) cooling of the suspension obtained in step (b);
(d) separation of the precipitate from the suspension;
(e) drying of the precipitate.

The invention further relates to a catalyst which can be obtained by the process of the invention and also to its use for the desulfurization of hydrocarbon streams.

The invention relates to a process for preparing a catalyst for the desulfurization of hydrocarbon streams, a catalyst for the desulfurization of hydrocarbon streams as can be obtained, for example, by means of this process, and also the use of the catalyst for the desulfurization of hydrocarbon streams.

Most catalysts are, particularly when they contain transition metals, poisoned by organic sulfur compounds and thus lose their activity. In many processes for the conversion of hydrocarbons, for example reforming of methane or other hydrocarbons, e.g. in the production of synthesis gas for methanol synthesis or for energy generation from methanol or other hydrocarbons in fuel cells, it is necessary to reduce the sulfur content of the hydrocarbon stream down to the ppb range.

The removal of the organic sulfur compounds from the hydrocarbon stream generally comprises two steps which are carried out in two separate reactors. In a first reactor, the organic sulfur compounds are reduced to hydrogen sulfide. For this purpose, the hydrocarbon stream to which a suitable reducing agent such as gaseous hydrogen has been added is passed, for example, over a catalyst which typically contains cobalt and molybdenum or nickel and molybdenum. Sulfur-containing compounds present in the gas, e.g. thiophenes, are in this way reduced to produce hydrogen sulfide.

After the reduction, the gas stream is fed to a second reactor in which the hydrogen sulfide which was originally present in the gas or has been formed in the reduction of organic sulfur compounds is absorbed on a suitable absorbent. For this purpose, the hydrocarbon stream usually flows through a bed of a solid absorbent, for example an absorbent bed of zinc oxide.

EP 1 192 981 A1 describes a process for preparing an agent for the desulfurization of hydrocarbon streams, in which a precipitate is precipitated from a mixture of a copper compound and a zinc compound, for example the nitrates, by means of aqueous solution of an alkaline compound such as sodium carbonate. The precipitate is separated off, washed, dried and calcined. The calcined product is processed to produce shaped bodies and the shaped bodies are then impregnated with a solution of an iron and/or nickel compound and the shaped bodies are subsequently calcined again. The content of iron and/or nickel in the calcined shaped bodies is preferably from 1 to 10% by weight.

U.S. Pat. No. 4,613,724 proposes a process for removing carbonyl sulfide (COS) from hydrocarbon streams, in which the hydrocarbon stream is passed over an absorbent which comprises zinc oxide and a promoter selected from the group consisting of aluminum oxide, aluminum silicates and mixtures thereof. In addition, calcium oxide can also be present as promoter. The proportion of promoter in the absorbent material is preferably not more than 15% by weight. The specific surface area of the absorbent material is preferably from 20 to 100 m²/g. The particle size of the absorbent material is preferably less than 2 mm and particularly preferably in the range from 0.5 to 1.5 mm. The absorbent material preferably contains from 85 to 95% by weight of zinc oxide, from 3 to 10% by weight of aluminum oxide or aluminum silicates and from 0 to 5% by weight of calcium oxide.

U.S. Pat. No. 5,348,928 describes a catalyst for the desulfurization of hydrocarbon streams, which contains, as hydrogenating component, from 4 to 10% by weight of a molybdenum compound, calculated as molybdenum oxide, and from 0.5 to 3% by weight of a cobalt compound, calculated as cobalt oxide. The catalyst further comprises a support component which contains from 0.5 to 50% by weight of a magnesium compound and from 0.3 to 10% by weight of a sodium compound, in each case calculated as oxide. The specific surface area of the catalyst is not less than 268 m²/g and the mean pore diameter is not more than 300 Å. The catalyst can be produced by, for example, impregnating the support with aqueous solutions of the salts of the active metal components.

U.S. Pat. No. 5,800,798 describes a process for producing fuel gas for fuel cells, in which a hydrocarbon stream having a sulfur content of not more than 5 ppm is passed over an absorbent to remove the sulfur. The absorbent comprises a copper-nickel alloy which has a ratio of copper to nickel of from 80:20 to 20:80 and a support material selected from the group consisting of Al₂O₃, ZnO and MgO. The total content of copper and nickel, calculated as metals, in the absorbent is from 40 to 70% by weight. To produce the fuel gas, the purified hydrocarbon stream can then be passed to steam reforming. The absorbent for sulfur has a specific surface area in the range from 10 to 400 m²/g and a pore volume in the range from 0.1 to 1.5 ml/g. The absorbent preferably comprises copper in a proportion of from 11 to 22% by weight, nickel in a proportion of from 21 to 30% by weight, zinc oxide in a proportion of from 46 to 50% by weight and aluminum oxide in a proportion of from 10 to 11% by weight, with the specific surface area being from 95 to 98 m²/g.

U.S. Pat. No. 5,302,470 describes a system for generating energy which comprises a fuel cell. The fuel gas is obtained from a hydrocarbon stream by steam reforming. To desulfurize the hydrocarbon stream, it is passed over a catalyst comprising copper and zinc, as a result of which the sulfur content is reduced to values of less than 5 ppb. The catalyst is prepared by coprecipitation of a copper compound and a zinc compound and, if desired, an aluminum compound.

DE 103 52 104 A1 describes a method of removing sulfur compounds from hydrocarbon-containing gases, in which catalysts, with the exception of activated carbons and zeolites, comprising copper, silver, zinc, molybdenum, iron, cobalt, nickel or mixtures thereof are used at temperatures of from −50 to 150° C., preferably from 0 to 80° C., and a pressure of from 0.1 to 10 bar, preferably from 0.8 to 4.5 bar. The catalysts produced in the examples are obtained either by means of a precipitation step or by means of an impregnation step. In the production of the catalysts by means of a precipitation step, a nitric acid mixture of suitable metal salts is initially charged and the soluble metal salts are precipitated by increasing the pH by addition of sodium carbonate. The precipitate is separated off, washed with water until no more sodium ions can be detected and then converted into the corresponding mixed oxide by calcination. In this way, mixed oxides of the following metal combinations are produced: Cu/Zn/Al, Cu/Zn/Zr, Cu/Zn/Al/Zr, Cu/Zn/Al/Zr/La, Cu/Zn/Al/Zr/Mg, Cu/Zn/Al/Zr/Ni, Cu/Zn/Al/Zr/Si. In the production of the catalysts by impregnation, aluminum oxide extrudates are treated with an aqueous solution of suitable metal salts. After impregnation, the catalysts are dried and calcined.

DE 103 40 251 A1 describes a method of removing sulfur compounds from hydrocarbon-containing gases, in which copper- and molybdenum-containing catalysts are used together at temperatures of from −50 to 150° C. and a pressure of from 0.1 to 1 bar. The two catalysts can either be arranged in series, in which case the copper-containing catalyst is particularly preferably positioned upstream of the molybdenum-containing catalyst, or as a mixture of the two catalysts. The latter is preferred, in particular, when the catalysts are used in relatively small plants. When the catalysts are used as a mixture, the copper- and molybdenum-containing catalysts are firstly produced separately and then mixed.

DE 1 121 757 describes a porous supported catalyst for the hydrogenative desulfurization of sulfur-containing hydrocarbons, which catalyst comprises oxides or sulfides of molybdenum and of iron group metals as hydrogenating component. As metals of the iron group metals, preference is given to using cobalt and nickel.

DE 102 60 028 A1 describes a method of removing sulfur compounds from hydrocarbon-containing gases, in which copper- and molybdenum-containing catalysts are used together at temperatures of from −50 to 150° C. and a pressure of from 0.1 to 1 bar. As suitable catalysts, Cu/Zn/Al, Cu/Zn/Zr, Cu/Zn/Al/Zr, Cu/Zn/Al/Zr/La, Cu/Zn/Al/Zr/Mg, Cu/Zn/Al/Zr/Ni, Cu/Zn/Al/Zr/Si and Al/Mo/Cu/Ba catalysts are described in the examples.

EP 1 192 981 A1 describes a process for preparing a desulfurizing agent, in which a precipitate is precipitated from an aqueous mixture of a copper compound and a zinc compound by means of alkali. The precipitate is calcined and shaped bodies are produced from the calcined precipitate. The shaped bodies are impregnated with iron- and/or nickel-containing compounds and the impregnated shaped body is calcined again. To activate the catalyst, it is reduced in a stream of hydrogen.

EP 0 600 406 B2 describes a process for the desulfurization of hydrocarbons, in which the hydrocarbon stream comprises unsaturated hydrocarbons and is admixed with from 0.01 to 4% by volume of hydrogen gas. The hydrocarbon stream is passed over a copper/zinc desulfurizing agent which has a copper/zinc atomic ratio of from 1:0.3 to 1:10 and is obtainable by a coprecipitation process. The copper/zinc desulfurizing agent is prepared by firstly preparing an aqueous solution of the corresponding metal salts and then precipitating a precipitate by addition of alkali, for example sodium carbonate. In one of the examples, a precipitate is precipitated from an aqueous solution of copper nitrate, zinc nitrate and ammonium paramolybdate by means of sodium carbonate solution. Washing with water, drying and calcination gives a mixture of copper oxide-zinc oxide-molybdenum oxide which can be used for hydrogenative desulfurization.

EP 0 427 869 B1 describes a fuel cell power generation system which comprises a desulfurization unit which comprises at least one copper/zinc desulfurization reactor. In the examples, mixed copper/zinc/aluminum oxides are used as desulfurization agent.

GB 1,011,001 describes a catalyst for the desulfurization of organic compounds, with the catalyst comprising a support which comprises finely divided zinc oxide and a compound comprising hexavalent molybdenum and oxygen. The catalyst can, in a preferred embodiment, comprise a promoter such as copper oxide. To produce the catalyst, zinc oxide is reacted in the presence of water with a compound which reacts with the zinc oxide to form zinc carbonate. The mixture is shaped, dried and calcined in order to obtain a finely divided zinc oxide. Before, during or after the preparation of the zinc oxide, a compound comprising hexavalent molybdenum and oxygen is added. For this purpose, the zinc oxide can, for example, be impregnated with an aqueous solution of ammonium molybdate. The impregnation may have to be repeated a number of times in order to be able to apply sufficient amounts of molybdate to the support. In another embodiment, the catalyst is produced by kneading a mixture of zinc oxide, water and ammonium carbonate and adding the desired amount of zinc molybdate or molybdic acid and, if appropriate, copper carbonate to the mixture. The examples describe the production of a copper/zinc/molybdenum catalyst, in which zinc oxide, ammonium hydrogencarbonate and water are kneaded. Molybdic acid and basic copper carbonate are added to this mixture. The mixture is shaped to produce shaped bodies, dried and then calcined at from 300 to 350° C. In this process, the copper and molybdenum salts are thus converted into the form of their oxides only by calcination of the dried shaped body.

To make very substantial desulfurization of the hydrocarbon stream possible, the hydrogenation catalysts used in the desulfurization of hydrocarbon streams should have a high hydrogenation activity towards sulfur-containing organic compounds, for example thiophene. The sulfur absorbent should, firstly, have a high affinity for sulfur so as to make it possible to reduce the sulfur content to a very low level and, secondly, have a high sulfur uptake capacity so as to achieve long operating lives of the absorbent, i.e. very long intervals until the absorbent has to be replaced by a new fresh absorbent. Furthermore, the hydrogenation catalyst should display a very low decrease in its hydrogenation activity over its life.

The extent of desulfurization in the hydrodesulfurization depends on the sulfur content of the gas stream to be desulfurized, the temperature at which the process is operated and on the activity of the catalyst. Typical catalysts for hydrodesulfurization are produced by impregnating supports such as aluminum oxide with molybdenum or tungsten admixed with promoters such as cobalt or nickel. Customary catalysts for hydrodesulfurization are, for example, mixtures of cobalt and molybdates on aluminum oxide, nickel on aluminum oxide, or mixtures of cobalt and molybdates which are admixed with nickel as promoter and are supported on aluminum oxide.

A first object of the invention is to provide a process for preparing a catalyst for the desulfurization of hydrocarbon streams, by means of which inexpensive desulfurization of hydrocarbon streams is made possible. This hydrogenation catalyst should have a high activity for the reduction of organic sulfur compounds and the absorbent should have a high affinity for sulfur and a high uptake capacity so that a reduction of the sulfur content in the hydrocarbon stream down to the ppb range is made possible.

This object is achieved by a process having the features of claim 1. Advantageous embodiments of the process of the invention are subject matter of the dependent claims.

The process of the invention for preparing a catalyst for the desulfurization of hydrocarbon streams comprises the steps:
a) preparation of an aqueous suspension comprising:
   a thermally decomposable copper source,
   a thermally decomposable molybdenum source, and
   a solid zinc source;
b) heating of the aqueous suspension to a temperature at which the thermally decomposable copper source and the thermally decomposable molybdenum source decompose so that a suspension of a precipitate comprising zinc compounds, copper compounds and molybdenum compounds is obtained;
c) cooling of the suspension obtained in step (b);
d) separation of the precipitate obtained in the thermal decomposition from the suspension;
e) drying of the precipitate.

In the process of the invention, the catalytically active metals copper and molybdenum are precipitated by thermal decomposition of a thermally decomposable copper source and a thermally decomposable molybdenum source onto a solid zinc source, preferably zinc oxide, which serves as support material. The copper source and the molybdenum source then form a precipitate which is precipitated adjacent to or on the solid zinc source. After drying and, if appropriate, a subsequent calcination step, a solid which has a very high surface area is therefore obtained. The activation of the catalyst results in formation of very small copper crystallites. A very active catalyst is therefore obtained.

In the process of the invention, an aqueous solution of the thermally decomposable copper compound and the thermally decomposable molybdenum compound is firstly prepared and the solid zinc compound, in particular zinc oxide, is introduced into this.

For the purposes of the invention, a thermally decomposable copper compound or a thermally decomposable molybdenum compound is a compound which can be converted into copper oxide or molybdenum oxide on heating. This preferably occurs as a result of the thermally decomposable copper compound or the thermally decomposable molybdenum compound comprising an anion or cation which can be eliminated on heating, for example a carbonate or hydrogencarbonate ion or an ammonium ion. A thermally decomposable copper or molybdenum source is particularly preferably a compound which comprises anions or cations which can be driven off from an aqueous solution of the copper or molybdenum source by means of steam. Such anions or cations are, for example, the ammonium ion or carbonate or hydrogencarbonate ions. The thermal decomposition forms poorly defined compounds such as basic oxides, hydroxocarbonates, etc., which can be converted into copper oxide or molybdenum oxide in a calcination step.

Suitable copper compounds which can be converted, if appropriate after an additional calcination step, into copper oxide are, for example, copper carbonate, copper hydroxocarbonates, copper hydroxide, copper nitrate or salts of organic acids such as copper formate, copper oxalate or copper tartrate.

The thermally decomposable copper compound is preferably selected so that thermal decomposition forms no products which interfere in the preparation of the catalyst, in particular reduce its activity, for example chloride ions. The thermally decomposable copper compound is preferably selected so that thermal decomposition forms gaseous or water-soluble compounds which can preferably be driven off from the aqueous suspension by passing in an inert gas or, for example, steam. Very particular preference is given to using a tetramminecopper complex as thermally decomposable copper compound, with particular preference being given to tetramminecopper carbonate Cu(NH₃)₄CO₃.

Suitable molybdenum compounds which can be converted, if appropriate after an additional calcination step, into molybdenum oxide are, for example, molybdates having volatile cations, e.g. ammonium molybdates, molybdic acid or molybdenum salts of organic acids.

The thermally decomposable molybdenum compound is preferably likewise selected so that thermal decomposition results in elimination of gaseous or water-soluble compounds which can preferably be driven off from the solvent, for example by heating or passing inert gases through it. Preference is given to using an ammonium molybdate, for example (NH₄)₆Mo₇O₂₄*4 H₂O, as thermally decomposable molybdenum compound.

Suitable zinc compounds which can be converted directly into zinc oxide in a calcination step are, for example, zinc carbonate, zinc hydroxide, zinc hydroxycarbonates or zinc salts of organic acids, e.g. zinc formate, zinc acetate or zinc oxalate. The compounds can be used either alone or as mixtures of the zinc compounds. It is also possible for zinc oxide to be used directly in the reaction, which is particularly preferred.

As zinc oxide, it is possible to use a zinc oxide which has a comparatively low specific surface area, for example in the region of about 5 m²/g. However, it is also possible to use a zinc oxide which has a relatively high specific surface area. Such a zinc oxide can, for example, be obtained by addition of alkali metal hydroxides and/or alkali metal carbonates to water-soluble zinc salts, with the precipitate being able to be calcined directly after having been separated off and dried or after preparation of the catalyst of the invention. Such a zinc oxide preferably has a specific surface area of more than 20 m²/g, preferably more than 50 m²/g. As an alternative, the zinc oxide can also be obtained by calcination of a precipitate which is obtained by mixing zinc hydroxide and zinc carbonate in water.

For the preparation of the suspension, the solvent used is, water. Apart from water, further polar solvents such as glycol, alcohols, dimethylformamide or dimethyl sulfoxide may be added. Preference is given to using only water as solvent.

The order in which the components for preparing the suspension are introduced into the solution is not subject to any restrictions. It is possible firstly to introduce the solid zinc source, in particular zinc oxide, into the water and subsequently to add the thermally decomposable copper source and the thermally decomposable molybdenum source to the aqueous suspension. However, it is likewise possible firstly to dissolve the thermally decomposable copper source and the thermally decomposable molybdenum source at least partially in water and only then introduce the solid zinc source, most preferably the zinc oxide. Likewise, it is possible firstly to dissolve the copper source or the molybdenum source fully or partially in water, then to introduce the solid zinc source, preferably zinc oxide, into the solution and subsequently to add the remaining molybdenum or copper source to the mixture.

The components of the suspension can be introduced into the solvent, preferably water, at room temperature. However, to accelerate the dissolution process, the aqueous suspension can be heated, with the temperature preferably being selected so that no decomposition of the thermally decomposable copper source or of the thermally decomposable molybdenum source yet occurs. The aqueous suspension is preferably prepared at temperatures in the range from 15 to 60° C., preferably from 20 to 50° C. The aqueous suspension is preferably stirred. Customary stirrers can be used for this purpose.

The concentration of the thermally decomposable copper source in the aqueous suspension is preferably in the range from 0.01 to 0.2 mol/l, more preferably in the range from 0.015 to 0.1 mol/l, particularly preferably in the range from 0.02 to 0.075 mol/l.

The concentration of the thermally decomposable molybdenum source in the total aqueous suspension is preferably in the range from 0.01 to 0.2 mol/l, more preferably in the range from 0.015 to 0.1 mol/l, particularly preferably in the range from 0.02 to 0.075 mol/l.

The content of solid zinc source, preferably zinc oxide, in the aqueous suspension is preferably in the range below 300 g/l, since otherwise the viscosity of the mixture may increase too much. In order that the amount of solvent does not increase excessively, the content of solid zinc compound is preferably greater than 50 g/l, particularly preferably in the range from 100 to 200 g/l.

The solids content of the aqueous suspension is particularly preferably less than 60% by weight, very particularly preferably less than 50% by weight. The solids content of the aqueous suspension is very particularly preferably from 5 to 30% by weight, more preferably from 10 to 20% by weight.

The aqueous suspension is subsequently heated to a temperature at which both the thermally decomposable copper source and the thermally decomposable molybdenum source decompose and a precipitate comprising zinc compounds, copper compounds and molybdenum compounds is formed. The aqueous suspension already contains the solid zinc source, preferably zinc oxide, before decomposition of the thermally decomposable copper or molybdenum source. The thermal decomposition additionally forms a copper- or molybdenum-containing precipitate which can deposit on the solid zinc source. The appropriate temperature depends on the copper and molybdenum compounds used. The aqueous suspension can then appropriately be, for example, heated to boiling. Preference is given to temperatures in the range above 80° C., particularly preferably in the range from 90 to 120° C.

Thermal decomposition is preferably carried out so that a cation or an anion of the copper source or the molybdenum source is driven off by, for example, heating the aqueous suspension so that such a compound is removed from the aqueous suspension together with the water or solvent which is distilled off. Removal of the compound can, for example, also be effected by passing an inert gas or steam through the mixture so that an appropriate compound containing the anion or cation to be removed is driven off from the mixture.

Before the aqueous suspension is heated to a temperature at which decomposition of the copper source and the molybdenum source occurs, the temperature can also firstly be held at a temperature which is above room temperature but below the temperature at which decomposition commences. Suitable temperatures are, for example, in the range from 40 to 80° C., preferably from 50 to 70° C. The period of time for which the aqueous suspension is held at this temperature is preferably greater than 2 hours, more preferably in the range from 10 to 48 hours. During this time, dissolution and precipitation processes may occur on the solid zinc source and have a favorable influence on the surface of the catalyst.

The suspension obtained after the thermal decomposition of the copper and molybdenum source is cooled, preferably to a temperature in the range from 10 to 30° C., more preferably from 15 to 25° C., in particular about room temperature. Cooling can be effected actively by cooling the suspension by means of a coolant or a cooling device. However, it is usually sufficient to cool the suspension by allowing it to stand.

After the thermal decomposition of the copper and molybdenum source, the suspension can be aged. Aging can take place for at least 1 hour, preferably at least 10 hours. At longer aging times, no significant change in the catalyst properties is observed. Aging is preferably stopped after not more than 100 hours, preferably not more than 40 hours.

The precipitate is subsequently separated off from the suspension. Conventional processes may be used for this purpose, for example, filtration or centrifuging. However, it is also possible to evaporate the solution to leave the solid behind.

The precipitate can subsequently be dried and, if appropriate, milled in order to obtain a finer powder. Drying and milling can be carried out in customary apparatuses. The mean particle size D₅₀ after milling is preferably less than 100 μm, more preferably from 0.1 to 10 μm, particularly preferably from 0.2 to 5 μm.

The catalyst can subsequently be calcined. The powder can be processed in a customary manner to form shaped bodies, for example pellets or extrudates of any shape, with calcination being able to be carried out either on the powder or, preferably, on the shaped body.

The pH of the aqueous suspension comprising the thermally decomposable copper source, the thermally decomposable molybdenum source and the solid zinc source is preferably set to a value of more than 9, preferably about 9.5, before preparation of the precipitate or the thermal decomposition. When strong bases such as alkali metal hydroxides are used, the pH can also rise to values of more than 10.5.

For this purpose, ammonium hydrogencarbonate or ammonium carbonate is preferably added to the aqueous suspension prepared in step (a). The ammonium hydrogencarbonate can be introduced in solid form, as a solution or by passing ammonia and carbon dioxide into the mixture. The concentration of the ammonium hydrogencarbonate in the mixture is preferably in the range from 0.1 to 2 mol/l, more preferably from 0.2 to 0.8 mol/l.

The pH of the mixture is preferably set by addition of ammonia. The ammonia can for this purpose be introduced as gas or preferably as an aqueous solution.

If appropriate, carbon dioxide or aqueous ammonia admixed with carbon dioxide or ammonium hydrogencarbonate can also be introduced into the mixture. The ratio of ammonia to carbon dioxide in the mixture is preferably in the range from 1:1 to 2:1, preferably from 1.2:1 to 1.5:1.

The alkaline pH and the presence of the ammonia hydrogencarbonate promotes the dissolution and precipitation processes on the zinc source, in, particular the zinc oxide, so that, if appropriate after drying and calcining, a zinc oxide having a higher specific surface area is formed.

For the thermal decomposition, the aqueous suspension is preferably heated to a temperature of at least 90° C., preferably about 100° C. Heating is preferably carried out under atmospheric pressure. Customary apparatuses, for example heating coils or heating mantles, can be used for heating.

In a particularly preferred embodiment, steam is passed through the aqueous suspension to effect thermal decomposition. The steam can be introduced by means of customary apparatuses. For example, a ring-shaped inlet manifold provided with openings through which the steam is introduced into the mixture can be provided in the reaction vessel. The steam at the same time drives any ammonia or ammonium carbonate liberated in the thermal decomposition in the form of its decomposition products out of the mixture.

In a preferred embodiment, the ammonium content of the aqueous suspension is reduced to a value of less than 1000 ppm in step (b). This can be achieved, for example, by passing steam through the suspension until the ammonium content has decreased to the desired value. However, it is also possible to distil off part of the water, with the ammonia or the ammonium carbonate going over with the distillate.

In a particularly preferred embodiment of the process of the invention, the aqueous suspension of thermally decomposable copper source, thermally decomposable molybdenum source and solid zinc source is milled finely before the preparation of the precipitate. The milling results in activation of the solid components as a result of the fresh fracture surfaces which are continually produced during milling. The milling preferably commences during the preparation of the aqueous suspension and can also be continued to the end of the preparation of the precipitate or to the end of the thermal decomposition. The milling can in principle also be carried out only in one of the steps of the preparation, i.e. during preparation of the aqueous suspension or during preparation of the precipitate. During the preparation of the precipitate, i.e. the thermal decomposition of the copper or molybdenum source, milling can be carried out by discharging the suspension formed from the reaction vessel and feeding it into a mill. After milling, the suspension is then fed back into the reaction vessel.

Milling can, for example, also be carried out during aging of the suspension, with the suspension being able, as mentioned above, to be held at a temperature in the range from 40 to 70° C. In this case, milling may take place both during the aging step carried out, if appropriate, before thermal decomposition and also during the aging step carried out after thermal decomposition.

Milling is preferably carried out until the mean particle size D₅₀ of the particles in the suspension is less than 100 μm, preferably less than 5 μm, in particular less than 1 μm. The mean particle size D₅₀ of the particles is the value at which 50% of the particles have a larger diameter and 50% of the particles have a smaller diameter than the D₅₀ value. The D₅₀ can, for example, be determined by laser granulometry (DIN 13320-1).

The milling of the mixture preferably comprises at least one cycle, preferably at least five cycles, particularly preferably at least ten cycles. In the present context, a cycle is a milling step in which the total amount of the suspension has passed once through the milling apparatus used.

Milling of the suspension can in principle be carried out in any suitable milling apparatus. The milling of the suspension is preferably carried out in an annular gap mill. One example of a suitable annular gap mill is the annular gap mill MS 32 from FrymaKoruma GmbH, D-79395 Neuenburg.

In a further, preferred embodiment, as already mentioned above, the precipitate obtained in the thermal decomposition is aged for at least 2 hours. The precipitate is preferably aged for a longer period of time, preferably more than 12 hours, particularly preferably more than 24 hours. Aging achieves additional activation of the zinc source, in particular the zinc oxide. The amphoteric zinc oxide may be dissolved, for example, as zinc hydroxide or zinc carbonate and precipitated again. The overall result is that the active specific surface area of the zinc source may be increased.

Aging is preferably carried out at a temperature in the range from 15 to 70° C., preferably at room temperature.

Particularly when the decomposition of the thermally decomposable copper source and the thermally decomposable molybdenum source forms essentially only products which can be converted by calcining into the corresponding oxides of copper, molybdenum and zinc, the removal of the solvent and the drying of the precipitate can, according to a preferred embodiment, also be carried out by carrying out the isolation of the precipitate and the drying of the precipitate by spray drying. This gives a fine powder which, for example, can be processed directly to form shaped catalyst bodies.

Spray drying can be carried out directly from the suspension obtained in the thermal decomposition. However, it is also possible to remove part of the solvent in another way, for example by decantation, filtration or distillation, and to process the remaining suspension by spray drying to give a fine powder. The solids content of the suspension prior to spray drying is preferably from 10 to 30% (w/w), particularly preferably from 20 to 25%. Spray drying can be carried out in customary apparatuses under customary conditions.

The precipitate obtained in the thermal decomposition of the copper compound and the molybdenum compound usually still contains, in addition to the copper, molybdenum and zinc cations, anions of the compounds originally used, e.g. carbonate ions. In addition, the precipitated compounds are usually still at least partly in the form of hydroxo compounds. In a preferred embodiment, the precipitate or the powder obtained in step (e) is therefore additionally calcined.

The calcination is preferably carried out at a temperature of more than 200° C., more preferably more than 250° C., particularly preferably in the range 310-550° C., preferably for a period of at least 1 hour, preferably at least 2 hours, particularly preferably in the range from 2.5 to 8 hours.

The catalyst obtained by the process of the invention assumes both the function of hydrogenation catalyst and of sulfur absorbent. To ensure a sufficiently long operating life of the catalyst, the proportion of zinc oxide in the finished catalyst is preferably relatively high. Accordingly, the proportion of the zinc source, calculated as zinc oxide and based on the total amount of copper source, molybdenum source and zinc source, calculated in each case as an oxide, is preferably at least 80% by weight, preferably at least 90% by weight.

The amounts of the copper source, the molybdenum source and the zinc source are particularly preferably selected so that the catalyst has a copper content in the range from 0.1 to 20% by weight, preferably from 0.5 to 10% by weight, particularly preferably from 0.8 to 5% by weight, a molybdenum content in the range from 0.1 to 20% by weight, preferably from 0.5 to 10% by weight, particularly preferably from 0.8 to 5% by weight, and a zinc content in the range from 60 to 99.8% by weight, preferably from 80 to 99% by weight, particularly preferably from 90 to 98% by weight, in each case based on the weight of the catalyst (with no further ignition loss at 600° C.) and calculated as oxides of the metals.

The catalyst obtained by the process of the invention displays very good properties in the desulfurization of hydrocarbon streams. It makes it possible for reduction of sulfur-containing organic compounds and absorption of the hydrogen sulfide formed to be achieved simultaneously. The sulfur is bound by the zinc oxide in the immediate vicinity of the hydrogenation-active metal. To achieve the hydrogenation-catalytic activity, at least part of the molybdenum has to be present in the form of the sulfide. If the catalyst is operated for a prolonged period of time in a hydrocarbon stream which is free of sulfur-containing organic compounds, the molybdenum compound is depleted in sulfur and is thus deactivated. However, since the sulfur remains bound by the zinc oxide in the catalyst obtained by the process of the invention, the sulfur is available so that the catalyst immediately becomes active again when hydrocarbon streams containing sulfur-containing organic compounds are passed through it again.

The invention therefore further provides a catalyst for the desulfurization of hydrocarbon streams, which has a CuO content in the range from 0.1 to 20% by weight, preferably from 0.5 to 10% by weight, particularly preferably from 0.8 to 5% by weight, a ZnO content in the range from 60 to 99.8% by weight, preferably from 80 to 99% by weight, particularly preferably from 90 to 98% by weight, and an MoO₃ content in the range from 0.1 to 20% by weight, preferably from 0.5 to 10% by weight, particularly preferably from 0.8 to 5% by weight, based on the weight of the catalyst (based on a powder ignited at 600° C.).

The catalyst has a specific surface area, measured by the BET method, of at least 30 m²/g, preferably at least 40 m²/g, particularly preferably at least 50 m²/g. The specific surface area of the catalyst is preferably less than 500 m²/g, particularly preferably less than 100 m²/g. A suitable method of determining the specific surface area is described further below.

The total pore volume of the catalyst is preferably more than 120 mm³/g, more preferably more than 150 mm³/g, particularly preferably more than 180 mm³/g. The pore volume can be determined, for example, by mercury intrusion.

Furthermore, the catalyst of the invention has a characteristic pore radius distribution. In a pore radius range from 3.7 to 7 nm, the catalyst preferably has a pore volume measured by Hg intrusion of at least 20 mm³/g, more preferably at least 40 mm³/g, in particular in the range from 30 to 60 mm³/g. In a pore radius range of 7-40 nm, the catalyst preferably has a pore volume of more than 100 mm³/g, more preferably more than 120 mm³/g, particularly preferably more than 130 mm³/g. In this range of pore radii, the pore volume preferably does not exceed a value of 500 mm³/g, more preferably 250 mm³/g. The fraction of medium-sized transport pores in the range from 40 to 875 nm is at least 1 mm³/g, preferably at least 2 mm³/g, and is preferably not more than 100 mm³/g, more preferably not more than 50 mm³/g, particularly preferably not more than 20 mm³/g. The catalyst of the invention thus has a particularly high proportion of small pores.

In a preferred embodiment, the catalyst is made up of approximately spherical particles which preferably have a mean diameter D₅₀ in the range from 0.5 to 50 μm, particularly preferably from 1 to 10 μm. A narrow size distribution of the particles is achieved particularly when, in accordance with the above-described preferred embodiment, the suspension of thermally decomposable copper compound, thermally decomposable molybdenum compound and solid zinc compound is finely milled prior to the thermal decomposition and the suspension after thermal decomposition is dried by spray drying.

The invention further provides for the use of the above-described catalyst for the desulfurization of hydrocarbon streams. The desulfurization is carried out in a customary manner by passing the hydrocarbon stream together with a small amount of reducing agent, in particular hydrogen gas, over a bed of the catalyst.

The desulfurization is carried out under customary conditions. The reaction can, for example, appropriately be carried out in a temperature range from 260 to 550° C., at a hydrogen partial pressure of from 0.3 to 4 barg and an LHSV (liquid hourly space velocity) in the range from 0.1 to 20. The catalyst can be in the form of shaped bodies, for example pellets, or as granulated material. The diameter of the shaped bodies or granules is preferably in the range from 3 to 10 mm.

The catalyst of the invention is particularly suitable for the desulfurization of hydrocarbon streams which have a sulfur content of less than 500 ppm, particularly preferably less than 400 ppm. Such hydrocarbon streams are formed, for example, by natural gas or accompanying gas in petroleum recovery.

The invention is illustrated below with the aid of examples and with reference to the accompanying figures. In the figures:

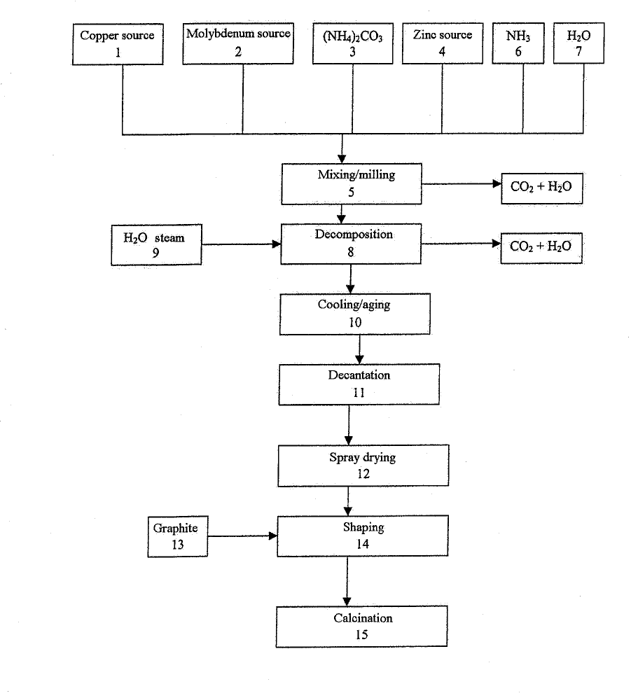

FIG. 1 shows a schematic block diagram of the process for preparing the catalyst of the invention;

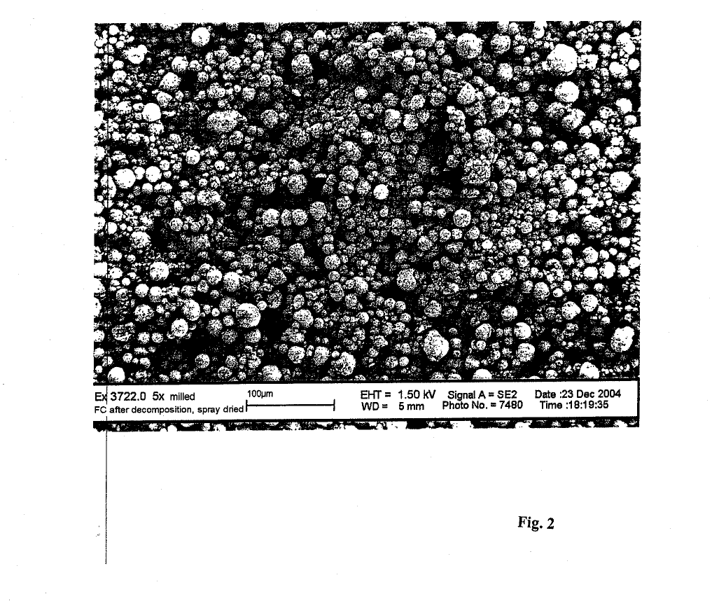

FIG. 2 shows an electron micrograph of a spray-dried catalyst before shaping and calcination; and

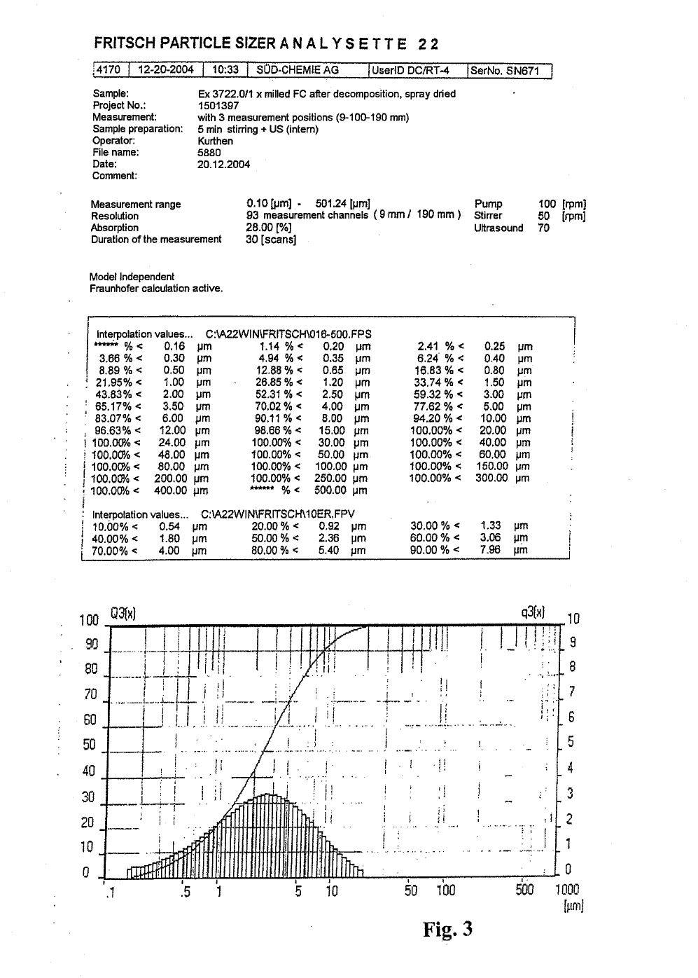

FIG. 3 shows a laser-granulometric analysis of the particle size distribution.

In FIG. 1, the preparation of the catalyst of the invention is shown schematically as a block diagram. In a first step, the thermally decomposable copper source 1 and the thermally decomposable molybdenum source 2 are dissolved in an aqueous solution of ammonium hydrogencarbonate 3 and the solid zinc source 4 is added to the solution to give an aqueous suspension 5 of the components. To set the pH and the NH₃/CO₂ ratio, an aqueous ammonia solution 6 or another suitable base, e.g. NH₃/CO₂ or NH₄/CO₃, can additionally be added to the aqueous suspension. To mix the starting materials, the aqueous suspension 5 can be heated to a temperature in the range from 25 to 50° C. In a preferred embodiment, the aqueous suspension 5 is subjected to intensive milling, for example in an annular gap mill. The temperature of the suspension during milling is in the range from about 10° C. to about 50° C. During mixing of the starting components and the intensive milling, small amounts of ammonia and carbon dioxide can be given off from the aqueous suspension. In the next step 8, the thermally decomposable copper source and the thermally decomposable molybdenum source are decomposed, for which purpose hot steam 9 is introduced into the aqueous suspenison. The temperature of the aqueous suspension rises locally to values of from about 50 to 103° C. as a result. The introduction of hot steam is continued until the ammonium content of the suspension has dropped to a concentration of less than 1000 ppm. Carbon dioxide and ammonia are liberated from the aqueous suspension in the decomposition of the thermally decomposable starting components. After the thermal decomposition is complete, the suspension is cooled to about room temperature (10). This can be followed by aging. On allowing the suspension to stand, the precipitate settles so that the supernatant clear solution can be decantered off (11). The suspension which remains is dried by spray drying 12 and the powder obtained in this way is shaped with addition of a shaping aid 13, for example graphite, to produce shaped bodies. The shaped bodies are subsequently calcined (14).

### Methods of Determination

For the determination of the physical parameters, the following methods were used:

### Surface Area/Pore Volume

The surface area was determined in accordance with DIN 66131 on a fully automatic nitrogen porosimeter from Micromeritics, model ASAP 2010.

### Pore Volume (Mercury Porosimetry)

The pore volume and the pore radius distribution were determined in accordance with DIN 66133.

### Loss on Ignition

The loss on ignition was determined in accordance with DIN ISO 803/806.

### Bulk Density

The bulk density was determined in accordance with DIN ISO 903.

### EXAMPLE 1

2637 g of ZnO and 158 g of (NH₄)₆Mo₇O₂₄×4H₂O were added to 528 g of an ammonium hydrogencarbonate solution (8.3% of CO₂, 12.4% of NH₃) and 427 g of a solution of Cu(NH₃)4CO₃ (Cu content: 40 g) and the mixture was heated while stirring from 25 to 50° C. over a period of 30 minutes. The mixture was subsequently stirred at 50° C. for a further 60 minutes. To decompose the copper and molybdenum compounds, steam was then passed through the mixture for 90 minutes, resulting in the temperature of the mixture increasing from 50° C. to 103° C. The introduction of steam was then stopped and the resulting suspension was cooled from 103° C. to 35° C. over a period of 14 hours. The supernatant clear solution was decantered off. The solution which had been decantered off still contained 0.06% by weight of NH₃ and 0.5 ppm of copper. The remaining suspension was dried by spray drying in countercurrent. The inlet temperature of the heated air was from 330° C. to 350° C. The temperature at the outlet of the dryer was from 110° C. to 120° C. Only traces of ammonia and carbon dioxide could be detected in the air leaving the dryer. The powder obtained was mixed with 2% of graphite as lubricant and then shaped on a tabletting press to give pellets. The pellets were subsequently calcined. For this purpose, the pellets were heated to 380° C. using a temperature ramp of 2° C./min and this temperature was then held for a further 2 hours.

The physical data of the catalyst obtained are summarized in Table 1.

### EXAMPLE 2

Example 1 was repeated with the suspension being maintained at 50° C. for 240 minutes prior to the thermal decomposition.

TABLE 1
physical and chemical characterization of the catalysts
from Examples 1 and 2 and of an internal SC standard.

| | | Example | Example | |
|---|---|---|---|---|
| | | 1 | 2 | Standard |
| ZnO (%)¹ | | 91.0 | 90.7 | 85.7 |
| CuO (%)¹ | | 1.79 | 1.86 | 1.8 |
| MoO₃ (%)¹ | | 4.3 | 4.15 | 4.4 |
| Loss on ignition | 600° C./2 h | 4.1 | 3.6 | 4.0 |
| (%) | | | | |
| Catalyst shape | | Pellet | Pellet | Pellet |
| Size | | 6 × 3 mm | 6 × 3 mm | 6 × 3 mm |
| BET surface area | (m²/g) | 45 | 50 | 20 |
| Bulk density | (g/l) | 1400 | 1380 | |
| Fracture | (N) | 63 | 89 | 111 |
| strength²; | | | | |
| calcined | | | | |
| Pore volume | (Hg) (mm³/g) | 215 | 186 | 132 |
| Relative pore | (Hg) (mm³/g) | | | |
| volume | | | | |
| | 7500-875 nm | 7.9 | 4.7 | 3.04 |
| | 875-40 nm | 21.6 | 21.8 | 12.68 |
| | 40-7 nm | 177.2 | 147.5 | 113.77 |
| | 7-3.7 nm | 8.4 | 11.9 | 2.86 |

¹Determined on a powder calcined at 600° C.
²Determined in accordance with DIN EN 1094-5

The catalysts obtained in Examples 1 and 2 do not differ significantly in their physical properties. In the case of Example 2, a lower pore volume was measured. This decrease is attributed to the longer aging time of the suspension, as a result of which the specific surface area decreases.

### EXAMPLE 3

Example 1 was repeated with the suspension obtained after the decomposition being aged at room temperature for one week.

### EXAMPLE 4

Example 1 was repeated with the suspension obtained after the decomposition being aged at room temperature for 24 hours.

### EXAMPLE 5

Example 1 was repeated with the mixture being milled in an annular gap mill (FRYMA MS-32, Fryma-Koruma GmbH, DE, 79395 Neuenburg) prior to the decomposition. The mixture had a solids content of 10%. The milling space was filled with 2.4 l of ZrO₂ balls. The milling gap was 7 mm. The rotational speed of the mill was about 645 rpm. The mixture was pumped through the mill at a rate of 3 1/min. To carry out milling, the suspension was passed once through the annular gap mill. Before spray drying, the suspension was aged at room temperature for 24 hours.

### EXAMPLE 6

Example 5 was repeated with the suspension being milled five times by means of an annular gap mill prior to the decomposition. For this purpose, the entire suspension was passed five times through the annular gap mill. After the decomposition, the suspension was aged at room temperature for 72 hours.

The physical data of the catalysts prepared in Examples 3 to 6 are summarized in Table 2.

TABLE 2
physical and chemical characterization
of the catalysts from Examples 3 to 6

| | Example 3 | Example 4 | Example 5 | Example 6 |
|---|---|---|---|---|
| ZnO (%)³ | 95.5 | 95.6 | 95.0 | 95.7 |
| CuO (%)³ | 1.7 | 1.6 | 1.8 | 2.1 |
| MoO₃ (%)³ | 3.9 | 4.2 | 4.5 | 5.3 |
| Loss on ignition (%) | 3.4 | 3.8 | 4.3 | 4.0 |
| calcined mold | | | | |
| 600° C./2 h | | | | |
| Catalyst shape | Pellet | Pellet | Pellet | Pellet |
| Size | 6 × 3 mm | 6 × 3 mm | 6 × 3 mm | 6 × 3 mm |
| BET surface area | 34.0 | 47.0 | 56.0 | 59.0 |
| (m²/g) | | | | |
| Bulk density (g/l) | 1450 | 1380 | 1350 | 1330 |
| Fracture strength², | 84.0 | 81.0 | 99.0 | 88.0 |
| calcined; (N) | | | | |
| Pore volume (Hg) | 170.0 | 212.0 | 188.0 | 192.0 |
| (mm³/g) | | | | |
| Relative pore | | | | |
| volume (Hg) | | | | |
| (mm³/g) | | | | |
| 7500-875 nm | 1.1 | 3.3 | 0.0 | 0.0 |
| 875-40 nm | 3.3 | 19.9 | 1.9 | 2.3 |
| 40-7 nm | 145.7 | 160.5 | 137.6 | 149.0 |
| 7-3.7 nm | 20.4 | 28.2 | 48.2 | 40.9 |

³Determined on a powder calcined at 600° C.

As a result of the longer aging time in Example 3, the specific surface area dropped from 47 to 34 m²/g and the pore volume decreased from 210 to 170 mm³/g.

As a result of the milling in Examples 5 and 6, the specific surface area increased significantly compared to samples which had not been milled. Furthermore, the pore volume in the range from 3.7 to 7 nm increased.

FIG. 2 shows an electron micrograph of the catalyst obtained in Example 6. The approximately spherical shape of the particles can be seen.

FIG. 3 depicts the particle size distribution of the catalyst obtained in Example 5. The D₅₀ is 2.36 μm.

### EXAMPLE 7

To determine the adsorption capacity for sulfur, 10 ml of the catalyst to be examined (crushed form, diameter 1.2 mm) were in each case weighed and subsequently introduced into a heatable tube reactor (diameter:20 mm, length: 600 mm). The outlet of the tube reactor was connected to a gas chromatograph (Agilent 6890 GC) which was equipped with an FID and an SCD for analysis of the reaction products (FID: flame ionization detector; SCD: sulfur-sensitive chemiluminescence detector; method: ASTM D-5504).

For the activation, the catalyst to be examined was firstly activated in a stream of methane gas which had been admixed with 100 ppm of sulfur and 2% of hydrogen gas for 48 hours. The activation was carried out at a temperature of 350° C. and a gas hourly space velocity (V_{gas}/V_{cat}·h) of 3000 h⁻¹.

To measure the sulfur uptake capacity, the activated catalyst was exposed to a stream of methane gas containing 20 ppm of ethyl mercaptan and 20 ppm of dimethyl sulfide and 2% of hydrogen gas at a temperature of 350° C., a pressure of 7.9 bar and a gas hourly space velocity of 6000 h⁻¹. The sulfur concentration in the reaction gas was measured at the outlet of the reactor. As soon as a value of 50 ppb of sulfur had been reached, the test was stopped, the catalyst sample was cooled to room temperature in the stream of methane gas and weighed again. The sulfur uptake was calculated from the weight difference. For comparison, the sulfur uptake capacity for the standard used in-house at Sud-Chemie AG (see Table 1) was also determined. The sulfur uptake capacities determined are shown in Table 3.

TABLE 3
Sulfur uptake capacity (% of sulfur, w/w)

| Cat_{Example 5} | Cat_{Example 6} | Standard |
|---|---|---|
| 14.3 | 14.8 | 11.3 |

### EXAMPLE 8

To determine the activity, 10 ml of the catalyst to be examined were in each case introduced into a tube reactor and activated as described in Example 7.

To examine the activity, the catalyst was exposed to a stream of methane gas to which 15 ppm of sulfur had been added in the form of dimethyl sulfide. The stream of methane gas further comprised 2% of hydrogen. The pressure was set to 7.9 bar. The gas hourly space velocity was 6000 h-¹. The temperature was varied in the range from 400 to 200° C. The temperature at which dimethyl sulfide is just being hydrogenated and absorbed, i.e. the temperature at which sulfur can be detected in the offgas stream, was determined. The results of the tests are summarized in Table 4.

TABLE 4
Sulfur concentration in the offgas stream (ppm)

| Catalyst | 300° C. | 275° C. | 250° C. | 225° C. | 200° C. |
|---|---|---|---|---|---|
| Standard | 0 | 0 | 1 | 3 | 4 |
| Example 5 | 0 | 0 | 0 | 0 | 2 |
| Example 6 | 0 | 0 | 0 | 0 | 1 |

1. A process for preparing a catalyst for the desulfurization of hydrocarbon streams, which comprises the steps:
a) preparing an aqueous suspension comprising:
a thermally decomposable copper source,
a thermally decomposable molybdenum source, and
a solid zinc source;
b) heating of the suspension to a temperature at which the thermally decomposable copper source and the thermally decomposable molybdenum source decompose so that a suspension of a precipitate comprising zinc compounds, copper compounds and molybdenum compounds is obtained;
c) cooling of the suspension obtained in step (b);
d) separating the precipitate from the suspension; and
e) drying of the precipitate,
wherein the aqueous suspension is finely milled before preparation for the precipitate.

2. The process as claimed in claim 1, wherein the proportion of the zinc source, calculated as zinc oxide and based on the total amount of thermally decomposable copper source, thermally decomposable molybdenum source and zinc source, calculated in each case in its oxide form, is at least 80% by weight.

3. The process as claimed in claim 1, wherein the aqueous suspension comprising the thermally decomposable copper source, the thermally decomposable molybdenum source and the solid zinc source has a solids content of less than 40% by weight.

4. The process as claimed in claim 1, wherein the thermally decomposable copper source and/or the thermally decomposable molybdenum source are present in dissolved form in the aqueous suspension.

5. The process as claimed in claim 1, wherein the solid zinc source is zinc oxide or a zinc compound which can be decomposed thermally to zinc oxide.

6. The process as claimed in claim 1, wherein the thermally decomposable copper compound comprises a tetramminecopper complex.

7. The process as claimed in claim 1, wherein the thermally decomposable molybdenum compound comprises an ammonium molybdate.

8. The process as claimed in claim 1, wherein the pH of the aqueous suspension is set to a value of more than 9.

9. The process as claimed in claim 1, wherein the aqueous suspension comprises ammonium carbonate or ammonium hydrogencarbonate.

10. The process as claimed in claim 8, wherein the pH of the suspension is set by addition of ammonia.

11. The process as claimed in claim 1, wherein the thermal decomposition is effected by heating the aqueous suspension to a temperature of at least 90° C., preferably at least 100° C.

12. The process as claimed in claim 11, wherein the aqueous suspension is heated by passing steam through it.

13. The process as claimed in claim 12, wherein the steam is passed through the aqueous suspension until the ammonium content of the aqueous suspension has been reduced to a value of less than 1000 ppm.

14. (canceled)

15. The process as claimed in claim 1, wherein the milling is carried out so that the mean particle size D₅₀ of particles in the aqueous suspension is less than 100 μm.

16. The process as claimed in claim 1, wherein the milling of the aqueous suspension comprises at least one cycle.

17. The process as claimed in any claim 1, wherein the milling of the aqueous suspension is carried out in an annular gap mill.

18. The process as claimed in claim 1, wherein the precipitate is aged for at least 12 hours before being separated off from the aqueous suspension.

19. The process as claimed in claim 18, wherein the aging is carried out at a temperature in the range from 15 to 70° C.

20. The process as claimed in claim 1, wherein the drying of the precipitate is effected by spray drying.

21. The process as claimed in claim 1, wherein the precipitate is calcined after drying.

22. The process as claimed in claim 21, wherein the calcination is carried out at a temperature of more than 200° C., for a period of at least 1 hour.

23. The process as claimed in claim 1, wherein the amounts of the copper source, the molybdenum source and the zinc source in the mixture are selected so that the catalyst has a copper content in the range from 0.1 to 20% by weight, a molybdenum content in the range from 0.1 to 20% by weight and a zinc content in the range from 60 to 99.8% by weight, in each case based on the weight of the catalyst (ignited at 900° C.) and calculated as oxides of the metals.

24. A catalyst for the desulfurization of hydrocarbon streams, which has a CuO content in the range from 0.1 to 20% by weight, a ZnO content in the range from 60 to 99.8% by weight and an MoO₃ content in the range from 0.1 to 20% by weight, based on the weight of the catalyst (ignited at 900° C.) having a specific surface area measured by the BET method of at least 30 m²/g and wherein the catalyst has a pore volume in the pore radius range from 3.7 to 7 nm, measured by Hg intrusion, of at least 20 mm³/g.

25. The catalyst as claimed in claim 24 which has a specific surface area measured by the BET method of at least 40 m²/g.

26. The catalyst as claimed in claim 24 which has a pore volume in the pore radius range from 3.7 to 7 nm, measured by Hg intrusion, of at least 40 mm³/g.

27. The catalyst as claimed in claim 24 which is made up of approximately spherical particles which have a mean diameter in the range from 0.5 to 50 μm.

28. (canceled)
